(19) United States
(12) Patent Application Publication
(10) Pub. No.: US 2019/0139053 A1
(43) Pub. Date: May 9, 2019

(54) ENGINEERING CHANGE ANNOUNCEMENT MANAGEMENT SYSTEM

(71) Applicant: International Business Machines Corporation, Armonk, NY (US)

(72) Inventors: Thomas P. Catanzaro, HOPEWELL JUNCTION, NY (US); Michael R. Kane, HOPEWELL JUNCTION, NY (US)

(21) Appl. No.: 15/805,504

(22) Filed: Nov. 7, 2017

(51) Int. Cl. G06Q 30/00; G06Q 30/06; G06Q 10/08; G06Q 10/06; G06F 17/30

(52) U.S. Cl. CPC G06Q 30/014; G06Q 30/0603; G06F 17/30864; G06Q 10/06316; G06Q 10/083

(57) ABSTRACT

A method for execution of an engineering change announcement is provided. The method is implemented by an application stored on a memory of a device. The application includes program instructions executable by a processor of the device, which is in communication with a backend system. The method includes receiving an engineering change announcement query. The method includes retrieving a query result from the backend system in response to the engineering change announcement query. The method includes determining whether the query result identifies that the engineering change announcement exists with respect to the engineering change announcement query. The method includes providing the query result when the query result identifies that the engineering change announcement exists with respect to the engineering change announcement query. The method includes receiving a selection input with respect to the query result. The method includes executing the engineering change announcement in accordance with the selection input.

### BACKGROUND

The disclosure relates generally to an engineering change announcement (ECA) management system, and more specifically, to the disclosure relates to utilizing mobile and/or web applications in conjunction with ECA management databases to complete field wide ECAs.

In general, recall procedures for products in the field can include determining a status of the products, placing part orders, causing service actions, and tracking the progress of the same to ensure the best possible quality of the products for clients. Managing, applying, and tracking the recall procedures in a population of industrial or consumer products poses significant logistical challenges for project managers, field technicians, and order fulfillment personnel alike. For example, a difficult problem faced in managing, applying, and tracking the recall procedures today is a disjointed nature of processes and tools utilized to implement the recall procedures.

### SUMMARY

According to one or more embodiments, a method for execution of an engineering change announcement is provided. The method is implemented by at least one application stored on a memory of a device. The at least one application includes program instructions executable by a processor of the device. The device is in communication with a backend system. The method includes receiving, via a user interface of the at least one application, an engineering change announcement query. The method includes retrieving, by a processor of the device, a query result from the backend system in response to the engineering change announcement query. The method includes determining whether the query result identifies that the engineering change announcement exists with respect to the engineering change announcement query. The method includes providing, via the user interface of the device, the query result when the query result identifies that the engineering change announcement exists with respect to the engineering change announcement query. The method includes receiving, via the user interface of the device, a selection input with respect to the query result. The method includes executing, by the processor of the device, the engineering change announcement in accordance with the selection input.

According to one or more embodiments, the above method for execution of the engineering change announcement can be implemented as a system, a computer program product, and/or a device.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter is particularly pointed out and distinctly claimed in the claims at the conclusion of the specification. The forgoing and other features, and advantages of the embodiments herein are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 depicts an architecture in accordance with one or more embodiments;

FIG. 4 depicts a process flow of a device in accordance with one or more embodiments; and

FIG. 5 depicts a process flow of a backend system in accordance with one or more embodiments.

### DETAILED DESCRIPTION

In view of the above, embodiments disclosed herein may include a system, method, and/or computer program product (herein system) that enables coordination and execution of engineering change announcements (ECAs) via shared applications and databases. ECAs are notices or tickets authorizing upgrading, repairing, and/or replacing products or systems in the field, and supporting the billing of the related labor. For example, the system integrates management applications, databases, and software tools that otherwise cannot communicate via mobile- and web-applications and backend data services so that the mobile- and web-applications and the backend data services of the system can provide ECA information in an organized and succinct manner to project managers, field technicians, and order fulfilment personnel. Technical effects and benefits of the system include a simplified and streamlined field process, where status updates to orders and direct feedback to an ECA database create a closed-loop process for strong process controls.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

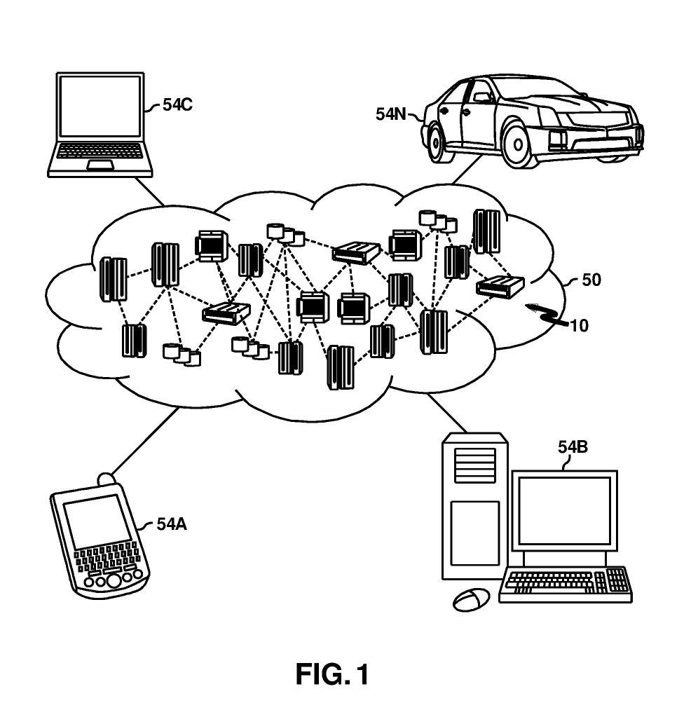

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

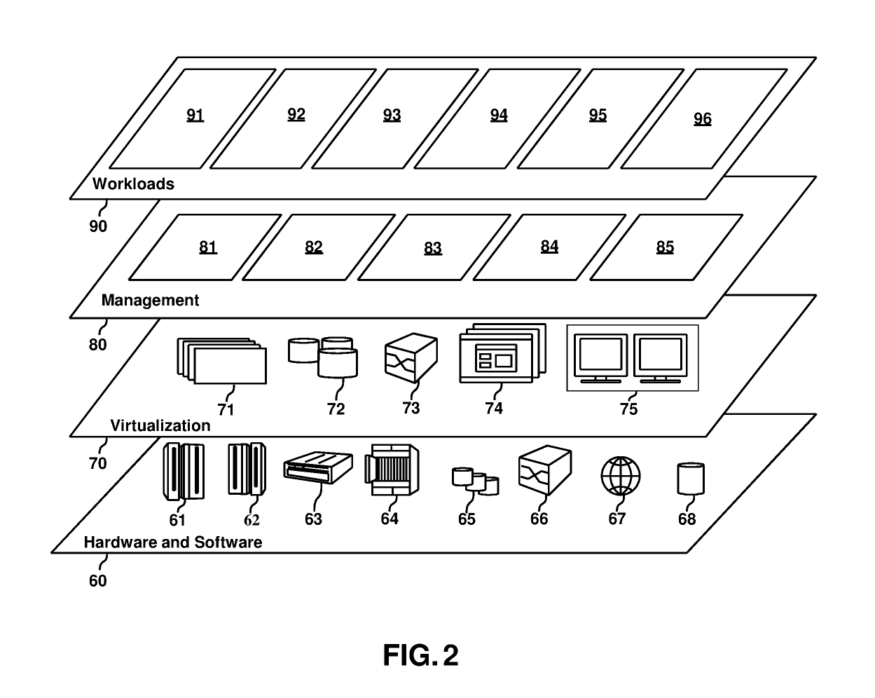

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

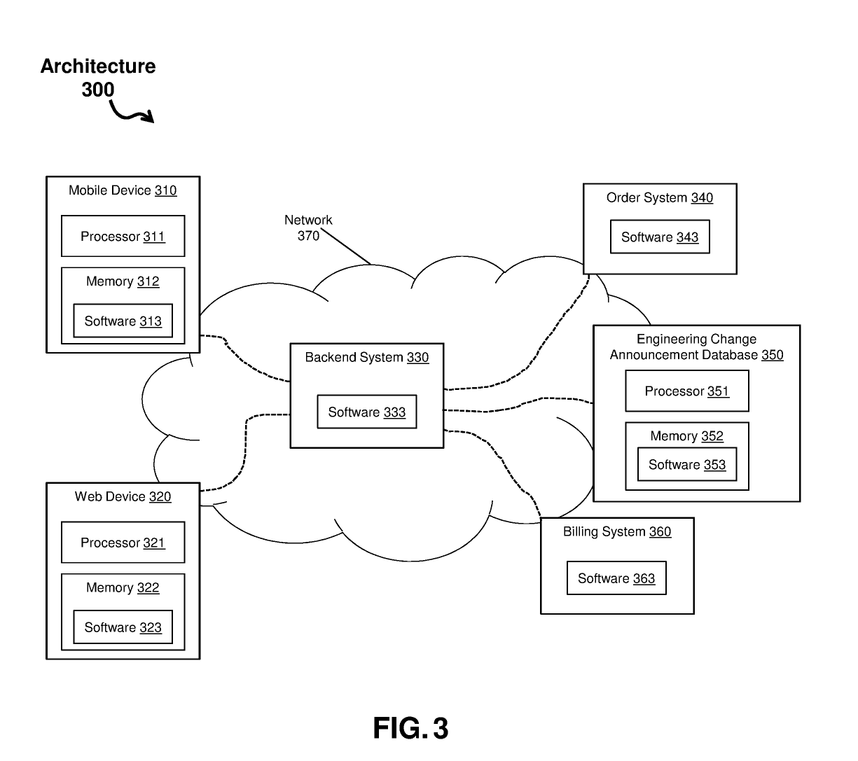

Turning now to FIG. 3, an architecture 300 is generally shown in accordance with an embodiment. The architecture 300 can be an electronic, computer framework comprising and/or employing any number and combination of computing device and networks utilizing various communication technologies, as described herein. The architecture 300 is easily scalable, extensible, and modular, with the ability to change to different services or reconfigure some features independently of others. The architecture 300 is an example and is not intended to suggest any limitation as to the scope of use or operability of embodiments described herein (indeed additional or alternative components and/or implementations may be used). Further, while single items are illustrated for items of the architecture 300, these representations are not intended to be limiting and thus, any item may represent a plurality of items.

The architecture 300 enables coordination and execution of ECAs via shared applications and databases. For instance, a product (e.g., a computer) or system (e.g., database farm) in the field purchased by a client (which can be collectively referred to as a field system) may experience errors or failures. Further, the field system may also require an upgrade after the passage of a period of time. A field technician evaluating the field system can utilize the architecture 300 to directly communicate ECAs to project managers and order fulfillment personnel. In this way, the coordination and execution of the ECAs by the architecture 300 provides field service operations and administrative operations. Field service operations include supporting queries for ECAs applicable to the field system, supporting the transmission of ECA background information, providing instructions for ECA installations, placing orders for ECA parts, providing order tracking information, and confirming completion of ECA parts installation (e.g., billing submission form the field). Administrative features include defining ECA candidates, creating rules for ECA part orders, tracking for ECA field penetration, providing and tracking field system status information, providing and tracking Warranty status, and providing applicable ECAs in response to queries.

As shown in FIG. 3, the architecture 300 comprises a mobile device 310, which includes a processor 311 and a memory 312 storing software 313 thereon. The architecture 300 comprises a web device 320, which includes a processor 321 and a memory 322 storing software 323 thereon. The architecture 300 comprises a backend system 330 that executes software 333 and an order system 340 that executes software 343. The architecture 300 comprises an engineering change announcement (ECA) database 350, which includes a processor 351 and a memory 352 storing software 353 thereon. The architecture 300 comprises a billing system 360 that executes software 363. The devices and systems of the architecture 300 communicate via a network 370.

The mobile device 310 can be any portable computer including hardware, software, or combination of hardware and software utilized to carry out computer readable program instructions by performing arithmetical, logical, and/or input/output operations. Examples of the mobile device 310 include a smart phone, tablet computers, laptops, cell phones, personal digital assistants, and the like. The processor 311, also referred to as a processing circuit, is coupled via a system bus to the memory 312 and various other components. The memory 312 can include a read-only memory (ROM) and/or a random access memory (RAM).

The software 313 comprises at least one application (e.g., a mobile application) that provides a tracking database and interfaces to supports web and mobile access to the backend system 330, the order system 340, the ECA database 350, and the billing system 360. For example, the mobile application when executed by the processor 311 provides ECA release documentation dissemination, technician orders (e.g., support for parts orders), real-time tracking of ECA execution status, warranty claims, ECA instruction support (e.g., access to ECA installation instructions), submission of ECA application status information, and the like. In this regard, the mobile application can provide querying operations for system records based on barcode scan or serial number search and for ECA order status.

The web device 320 can be any computer including hardware, software, or combination of hardware and software utilized to carry out computer readable program instructions by performing arithmetical, logical, and/or input/output operations. Examples of the web device 320 include desktop computers, terminal computers, servers, kiosks, and the like. The processor 321, also referred to as a processing circuit, is coupled via a system bus to the memory 322 and various other components. The memory 322 can include a read-only memory (ROM) and/or a random access memory (RAM). Similarly to the software 313 of the mobile device 310, the software 323 of the web device 320 can comprise at least one application (e.g., a web application) that provides a tracking database and interfaces to supports web and mobile access to the backend system 330, the order system 340, the ECA database 350, and the billing system 360. In this regards, the web application when executed by the processor 321 can also provide ECA release documentation dissemination, technician orders, real-time tracking of ECA execution status, warranty claims, ECA instruction support, and the like. In this regard, the web application can provide full ECA administrative features, system status views, order generation based upon existing records, and ECA overview and instructions.

The backend system 330 can be any computer including hardware, software, or combination of hardware and software and/or any cloud computing model of service delivery (described herein) utilized to carry out computer readable program instructions by performing arithmetical, logical, and/or input/output operations. Similarly, the order system 340, the ECA database 350, and the billing system 360 can also be such any computer and/or cloud computing model.

As shown in FIG. 3, by way of example only, the backend system 330, the order system 340, and the billing system 360 are cloud computing systems, while the ECA database 350 is a data server. Respectively, the software 333 is executable by the backend system 330, the software 343 is executable by the order system 340, the software 353 stored on the memory 352 is executable by the processor 351 of the ECA database 350, and the software 363 is executable by the billing system 360.

In accordance with one or more embodiments, the order system 340 stores and provides ECA information and/or system information, such as order processing requests and procedures for filling the order processing requests. The ECA database 350 stores and provides ECA information and/or system information, such as the ECAs themselves. The billing system 360 stores and provides ECA information and/or system information, such as warranty information.

In general, ECA information can include problem descriptions, ordering information and rules, installation instructions, client documentation, etc. Further, the system information can include model (type) and serial number of field systems, client information, field system locations, shipping information, order status, ECAs applicable to a field system, ECA eligible parts requiring replacement as part of an ECA, ECA completion status, system status, warranty status, maintenance agreement status, etc.

The order system 340, the ECA database 350, and the billing system 360 are disjoint systems that, despite possibly storing overlapping ECA and system information, do not communicate directly with each other. For example, the mobile device 310 and the web device 320 communicate over the network 370 through the backend system 330 to access the order system 340, the ECA database 350, and the billing system 360 can communicate (as shown by the dashed lines). In this regard, the backend system 330 provides an interface to the billing systems (e.g., warranty or billing applications to automate an ECA billing process) and an interface to the order system 340 (e.g., manufacturing fulfillment order processes and systems for order placement and status tracking). The network 370 is a system of computing components and electrical and radio connections that allow and support communications with nodes thereon.

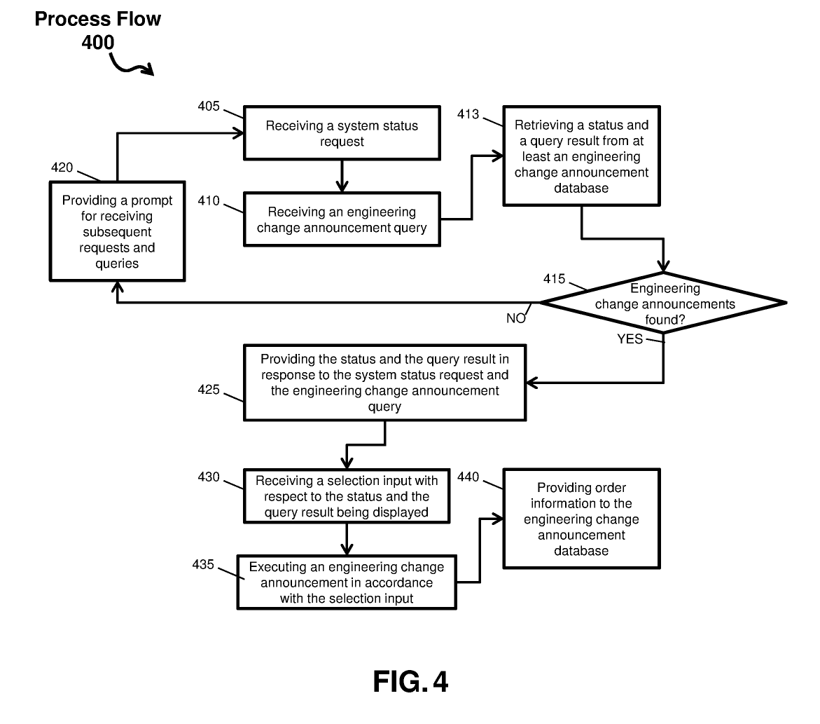

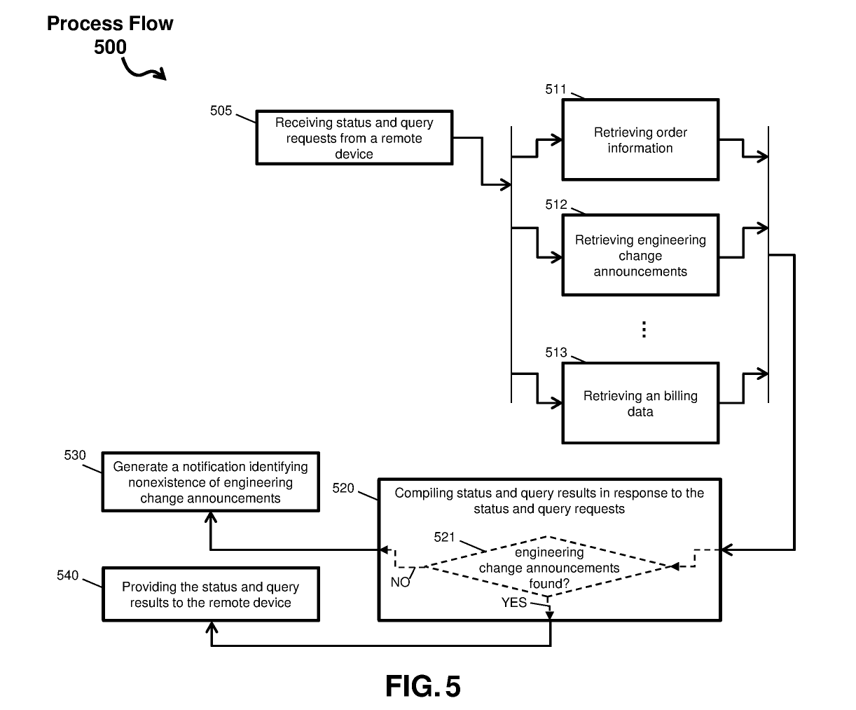

The architecture 300 will now be described with respect to process flows 400 and 500 of FIGS. 4 and 5, respectively. The process flow 400 illustrates how the web and mobile applications (of the software 313 and 323 of FIG. 3) utilize and share the backend system 330 of FIG. 3 and databases (e.g., the order system 340, the ECA database 350, and the billing system 360 of FIG. 3) to manage ECA status, place orders, access instructions, and document progress.

Turning now to FIG. 4, the process flow 400 begins at block 405, where an application receives a system status request. At block 410, the application receives an ECA query. For example, the mobile device 310 of FIG. 3 can be a smart phone with a camera. The camera is utilized to scan a code. The code can be an optical, machine-readable, representation of data describing a field system that carries the code itself. The data describing the field system can comprise at least a serial number. Examples of the code include, but are not limited to, one-dimensional codes with varying widths and spacings of parallel lines (e.g., a barcode) and two-dimensional codes utilizing rectangles, dots, hexagons and/or other geometric patterns (e.g., a quick response or QR code). Further, once the code is scanned, a user interface operated by a mobile application of the software 313 of FIG. 3 can be populated with known information (information local to the smartphone) about the associated field system. In turn, a field technician can utilize the user interface to input one or more request or queries that directly relate to the associated field system.

At block 413, the application retrieves a status and a query result from at least an ECA database. Returning to the FIG. 3 example, the mobile device 310 communicates over the network 370 to the backend system 330 to retrieve the status and the query result. The backend system 330, in turn, communicates over the network 370 with the ECA database 350 to obtain ECA and system information, which is then provided back to the mobile device 310. The status can include the status of the associated field system. The query result can include/identify whether any ECA exists with respect to the associated field system.

At decision block 415, the application analyzes the status and the query result to determine whether any ECAs are found. If no ECA s are found, then the process flow 400 proceeds to block 420 (as indicated by the NO arrow). At block 420, the application provides a prompt for receiving subsequent requests and queries. The application can also provide a status indicating that the associated field system requires no changes. If ECA s are found, then the process flow 400 proceeds to block 425 (as indicated by the YES arrow).

At block 425, the application provides the status and the query result in response to the system status request and the ECA query (via the user interface of the mobile device 310). At block 430, the application receives a selection input with respect to the status and the query result (being displayed by the user interface). The selection input is an instruction that identifies the ECA within the user interface and triggers an automatic implementation of the identified ECA. At block 435, the application executes ECA in accordance with the selection input.

The execution of the ECA can comprise initiating an automatic provisioning of software for a field system identified by the ECA. The execution of the ECA can comprise automatically ordering at least one part for a field system identified by the ECA. In this regard, at block 440, the application provides order information to the ECA database.

Turning now to FIG. 5, the process flow 500 will now be described. The process flow 500 illustrates how an application of the software 333 of the backend system 330 of FIG. 3 acts as an intermediary to manage ECA status, place orders, access instructions, and document progress. The process flow 500 begins at block 505, where the application receives status and query requests from a remote device. The remote device can be the mobile device 310 or the web device 320. The status and query requests can be received over the network 370. In response, the applicant performs one or more data retrieval operations.

For example, at block 511, the application of the backend system 330 can retrieve order information (from the order system 340). At block 512, the application of the backend system 330 can retrieve ECA (from the ECA database 350). At block 513, the application of the backend system 330 can retrieve billing data (from the billing system 360).

At block 520, the application compiles status and query results in response to the status and query requests. In accordance with one embodiment, the application analyzes the status and the query results to determine whether any ECAs are found (as shown by the dashed decision block 521). If no ECAs are found, then the process flow 500 proceeds to block 530 (as indicated by the NO arrow). At block 530, the application generates a notification identifying nonexistence of ECAs. The notification can then be provided by the backend system 330 to the remote device. If ECAs are found, then the process flow 500 proceeds to block 540 (as indicated by the YES arrow). At block 540, the application provides the status and query results to the remote device. In either case, the remote device can display the information provided by the backend system 330 to the user local to the remote device.

In view of the above, an artisan would readily recognize that the technical effects and benefits of the system herein include, but are not limited to, an integration of management tools and processes into a single process managed. This integration further provides support for a mobile application that allows for field technicians to query (while in the field) using barcodes or other systems identifiers, which simplifies and streamlines the field process. In this way, status updates to orders and feedback to an ECA database create a closed-loop process for strong process controls that improves a quality of operation of products and systems. Particularly, product and system failures can be reduced or eliminated via the system herein thereby providing longer and more efficient products/systems in the field.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for execution of an engineering change announcement, the method implemented by at least one application stored on a memory of a device, the at least one application comprising program instructions executable by a processor of the device, the device being in communication with a backend system, the method comprising:
receiving, via a user interface of the at least one application, an engineering change announcement query;
retrieving, by the processor of the device, a query result from the backend system in response to the engineering change announcement query;
determining whether the query result identifies that the engineering change announcement exists with respect to the engineering change announcement query;
providing, via the user interface of the device, the query result when the query result identifies that the engineering change announcement exists with respect to the engineering change announcement query;
receiving, via the user interface of the device, a selection input with respect to the query result; and
executing, by the processor of the device, the engineering change announcement in accordance with the selection input.

2. The method of claim 1, the processor-implemented method further comprising:
providing order information to an engineering change announcement database in communication with the backend system in accordance with the execution of the engineering change announcement.

3. The method of claim 1, the processor-implemented method further comprising:
providing, via the user interface of the device, a prompt for receiving subsequent engineering change announcement queries when the query result identifies that the engineering change announcement does not exist with respect to the engineering change announcement query.

4. The method of claim 1, the processor-implemented method further comprising:
receiving a system status request;
retrieving a status from the backend system in response to the system status request; and
providing, via the user interface of the device, the status and the query result in response to the system status request and the engineering change announcement query when the query result identifies that the engineering change announcement exists with respect to the engineering change announcement query.

5. The method of claim 1, wherein the execution of the engineering change announcement comprises automatically ordering at least one part for a field system identified by the engineering change announcement.

6. The method of claim 1, wherein the execution of the engineering change announcement comprises initiating an automatic provisioning of software for a field system identified by the engineering change announcement.

7. The method of claim 1, wherein the retrieving of the query result comprises sending communications to the backend system, which is in communication with at least an engineering change announcement database, the communications causing the backend system to coordinate data retrieval operations with the engineering change announcement database to procure the engineering change announcement.

8. A device for execution of an engineering change announcement, the device comprising a memory and a processor, the memory storing at least one application comprising program instructions executable by the processor, the device being in communication with a backend system, the program instructions causing the device to:
receive, via a user interface of the at least one application, an engineering change announcement query;
retrieve, by the processor of the device, a query result from the backend system in response to the engineering change announcement query;
determine whether the query result identifies that the engineering change announcement exists with respect to the engineering change announcement query;
provide, via the user interface of the device, the query result when the query result identifies that the engineering change announcement exists with respect to the engineering change announcement query;
receive, via the user interface of the device, a selection input with respect to the query result; and
execute, by the processor of the device, the engineering change announcement in accordance with the selection input.

9. The device of claim 8, the program instructions are further executable by the processor to cause the device to:
provide order information to an engineering change announcement database in communication with the backend system in accordance with the execution of the engineering change announcement.

10. The device of claim 8, the program instructions are further executable by the processor to cause the device to:
provide, via the user interface of the device, a prompt for receiving subsequent engineering change announcement queries when the query result identifies that the engineering change announcement does not exist with respect to the engineering change announcement query.

11. The device of claim 8, the program instructions are further executable by the processor to cause the device to:
receive a system status request;
retrieve a status from the backend system in response to the system status request; and
provide, via the user interface of the device, the status and the query result in response to the system status request and the engineering change announcement query when the query result identifies that the engineering change announcement exists with respect to the engineering change announcement query.

12. The device of claim 8, wherein the execution of the engineering change announcement comprises automatically ordering at least one part for a field system identified by the engineering change announcement.

13. The device of claim 8, wherein the execution of the engineering change announcement comprises initiating an automatic provisioning of software for a field system identified by the engineering change announcement.

14. The device of claim 8, wherein the retrieving of the query result comprises sending communications to the backend system, which is in communication with at least an engineering change announcement database, the communications causing the backend system to coordinate data retrieval operations with the engineering change announcement database to procure the engineering change announcement.

15. A computer program product for execution of an engineering change announcement, the computer program product comprising a computer readable storage medium having program instructions embodied therewith, the program instructions executable by a processor of a device to cause the device to:
receive, via a user interface of at least one application stored on a memory of the device, an engineering change announcement query;
retrieve, by the processor of the device, a query result from a backend system in response to the engineering change announcement query;
determine whether the query result identifies that the engineering change announcement exists with respect to the engineering change announcement query;
provide, via the user interface of the device, the query result when the query result identifies that the engineering change announcement exists with respect to the engineering change announcement query;
receive, via the user interface of the device, a selection input with respect to the query result; and
execute, by the processor of the device, the engineering change announcement in accordance with the selection input.

16. The computer program product of claim 15, wherein the program instructions are further executable by the processor to cause the device to:
provide order information to an engineering change announcement database in communication with the backend system in accordance with the execution of the engineering change announcement.

17. The computer program product of claim 15, wherein the program instructions are further executable by the processor to cause the device to:
provide, via the user interface of the device, a prompt for receiving subsequent engineering change announcement queries when the query result identifies that the engineering change announcement does not exist with respect to the engineering change announcement query.

18. The computer program product of claim 15, wherein the program instructions are further executable by the processor to cause the device to:
receive a system status request;
retrieve a status from the backend system in response to the system status request; and
provide, via the user interface of the device, the status and the query result in response to the system status request and the engineering change announcement query when the query result identifies that the engineering change announcement exists with respect to the engineering change announcement query.

19. The computer program product of claim 15, wherein the execution of the engineering change announcement comprises automatically ordering at least one part for a field system identified by the engineering change announcement.

20. The computer program product of claim 15, wherein the execution of the engineering change announcement comprises initiating an automatic provisioning of software for a field system identified by the engineering change announcement.
